(19) United States
(12) Patent Application Publication
(10) Pub. No.: US 2015/0163295 A1
(43) Pub. Date: Jun. 11, 2015

(54) VVoIP CALL TRANSFER

(71) Applicant: Viper Media S.a.r.l., Luxembourg (LU)

(72) Inventors: Michael Shmilov, Rishon LeZion (IL); Ido Iungelson, Rishon LeZion (IL); Ran Shalgi, Hod Hasharon (IL)

(21) Appl. No.: 14/397,204

(22) PCT Filed: Jun. 13, 2013
(86) PCT No.: PCT/IB2013/054835

§ 371 Date: Oct. 27, 2014

Related U.S. Application Data
(60) Provisional application No. 61/672,913, filed on Jul. 18, 2012.

(51) Int. Cl. H04L 29/08; H04M 3/58

(52) U.S. Cl. CPC H04L 67/104; H04M 3/58

(57) ABSTRACT

A method of pushing an ongoing VVo1P call from a first currently participating communication device belonging to an account having an account ID to a second communication device, comprising: sending by the first communication device a ‘transfer call’ message to a signaling service; sending by the signaling service the ‘transfer call’ message to at least one selected second communication device; if the call is not a P2P call, sending by one of the at least one selected second communication devices a ‘connect’ message to a relay server, the message comprising authentication information; sending by the signaling service a “call transferred” message to the first communication device; and continuing the ongoing call with the selected second communication device replacing the first communication device.

### FIELD OF THE INVENTION

The present invention pertains to the field of transmitting VVoIP between end-points over communication means and more particularly where multiple communication devices have the same account ID.

### CROSS-REFERENCE TO RELATED PATENT APPLICATIONS

This patent application claims priority from and is related to U.S. Provisional Patent Application Ser. No. 61/672,913, filed Jul. 18, 2012, this U.S. Provisional patent application incorporated by reference in its entirety herein.

### BACKGROUND

Voice or video over IP (VVoIP) commonly refers to the communication protocols, technologies, methodologies, and transmission techniques involved in the delivery of voice and/or video communications and multimedia sessions over Internet Protocol (IP) networks, such as the Internet.

The steps involved in originating a VVoIP call are signaling and media channel setup, digitization of the analog signal, encoding, packetization, and transmission as Internet Protocol (IP) packets over a packet-switched network. On the receiving side, similar steps (usually in the reverse order) such as reception of the IP packets, decoding of the packets and digital-to-analog conversion reproduce the original voice or video stream.

VVoIP applications/clients are available on many platforms—including smart phones, personal computers and Internet devices.

Each device must have a unique ID (DID) in the service network. In the simplest form, this would be nothing more than IP/port address the client is connected to the service with. It could be something else—for example, push services (Apple Push Notification Service, Google's C2DM) assign a unique “token” for each device that acts as its “address”.

The only requirement for a DID is uniqueness.

Multiple devices having different device IDs (DIDs) may share the same account ID, such as a user ID, an e-mail address or a phone number (or any other ID that defines a user, such as user name). For example, a smart phone and a desktop computer can both connect to a VVoIP service with the same phone number. The “normal” behavior for VVoIP services that support multiple devices connecting with the same account ID at the same time (e.g. Skype) is for messages to be received on all devices, each device's behavior being the same—regardless if there are other devices sharing the same account ID. One of the devices receiving a message normally picks up the call and continues the voice or video call, i.e. active device.

It may be beneficial if during a VVoIP call the active device would be able to transfer (“push”) the session to another device. For example, a session started on a user's computer may be continued on the user's smartphone if the user wishes to leave her home/office. Alternatively, a device may wish to “pull” a VVoIP call started on another device sharing its account ID.

### SUMMARY

According to a first aspect of the present invention there is provided a method of pushing an ongoing VVoIP call from a first currently participating communication device belonging to an account having an account ID to a second communication device, comprising: sending by the first communication device a ‘transfer call’ message to a signaling service; sending by the signaling service the ‘transfer call’ message to at least one selected second communication device; if the call is not a P2P call, sending by one of the at least one selected second communication devices a ‘connect’ message to a relay server, said message comprising authentication information; sending by the signaling service a “call transferred” message to the first communication device; and continuing said ongoing call with said selected second communication device replacing said first communication device.

The ‘transfer call’ message may comprise the relay server's IP port.

The first and second communication devices may share the same account ID.

The authentication information may comprise authenticating belonging to the same account ID.

The authentication information may comprise at least one of a device ID and a call token.

The account ID may comprise one of: user ID, e-mail address and phone number.

The second communication device may be selected by said first communication device.

The second communication device may be selected from communication devices being in near proximity to said first communication device.

The call may be a P2P call and sending by the signaling service the ‘transfer call’ message to at least one selected second communication device may comprise notifying said second communication device that traffic should pass via the relay server.

According to a second aspect of the present invention there is provided a method of pulling an ongoing VVoIP call from a first currently participating communication device to a second non-active communication device sharing the same account ID, comprising: discovering by said second device current active calls in said account ID; sending a request to a signaling service to pull a call from a first active device in one of said active calls; sending by a signaling service a ‘transfer call’ message to said first device and to said second device; if the call is not a P2P call, sending by said second device a ‘connect’ message to a relay server, said message comprising authentication information; sending by the signaling service a “call transferred” message to the first communication device; and continuing said ongoing call with said second communication device replacing said first communication device.

The ‘transfer call’ message may comprise the relay server's IP port.

The authentication information may comprise authenticating belonging to the same account ID.

The authentication information may comprise at least one of a device ID and a call token.

The account ID may comprise one of: user ID, e-mail address and phone number.

first communication device may be selected from communication devices being in near proximity to said second communication device.

The call may be a P2P call and sending by the signaling service the ‘transfer call’ message to said second communication device may comprise notifying said second communication device that traffic should pass via the relay server.

The authentication data may comprise at least one of a device ID and a call token.

The first and second communication devices may share the same account ID.

The account ID may comprise one of: user ID, e-mail address and phone number.

According to a third aspect of the present invention there is provided a method of pulling an ongoing VoIP or video call from a first currently participating communication device to a second proximate non-active communication device, comprising: receiving by said second communication device the call data from said first communication device; sending by said second communication device a ‘connect’ message to a relay server, said message comprising authentication data of said second communication device; sending by the relay server a ‘call transferred’ message to the first communication device; and continuing said ongoing call with said second communication device replacing said first communication device.

The authentication data may comprise at least one of a device ID and a call token.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic drawing of the system component for carrying out the present invention;

FIG. 2 is a schematic drawing showing the data transmission routes according to the present invention;

FIG. 3 is a flowchart showing the call transfer mechanism according to an embodiment of the present invention;

FIG. 4 is a flowchart showing the call transfer mechanism according to another embodiment of the present invention; and

FIG. 5 is a flowchart showing the call pulling mechanism according to the embodiment of FIG. 4.

### DETAILED DESCRIPTION OF PREFERRED EMBODIMENTS

The present invention provides a system and method for overcoming the disadvantages of existing VVoIP (Voice or video over IP) systems, by enabling the transfer of an ongoing voice or video call from one device to another.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

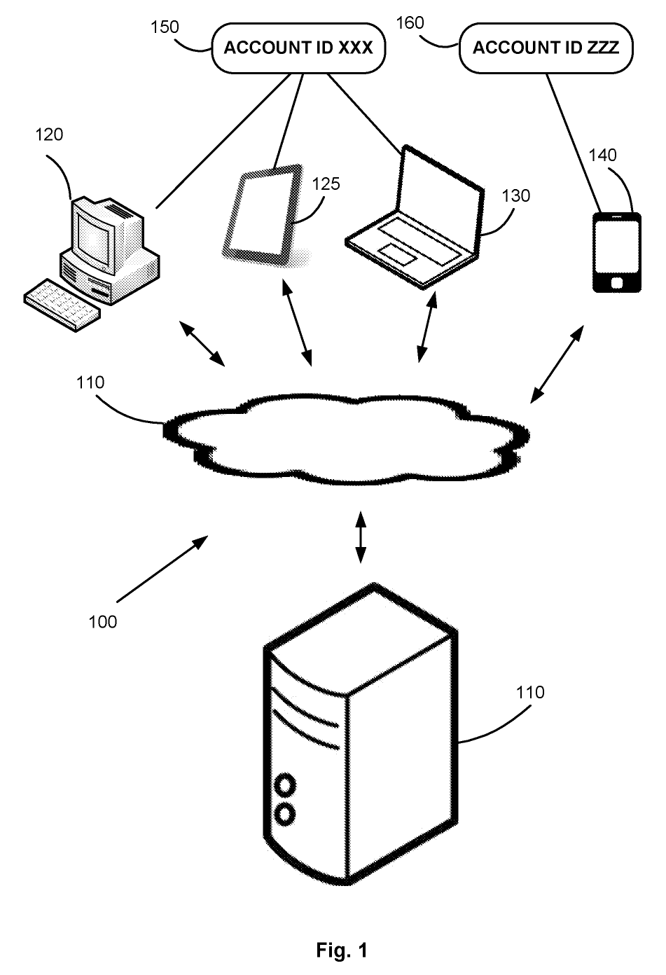

FIG. 1 is a schematic drawing showing the system component for carrying out the present invention. The system 100 comprises a plurality of exemplary communication devices belonging to a first user: a computer 120, a tablet PC 125, a laptop 130 sharing the same account ID 150, such as a user ID, an e-mail address or a phone number (or any other ID that defines a user, such as user name). The same user may additionally have other communication devices, e.g. a Smartphone 140, having a different account ID 160.

The communication devices (120, 125, 130, 140) communicate bi-directionally with the VVoIP service server 110 over a communication network such as the Internet, using a VVoIP application such as Viber (www.viber.com) or Skype (www.skype.com).

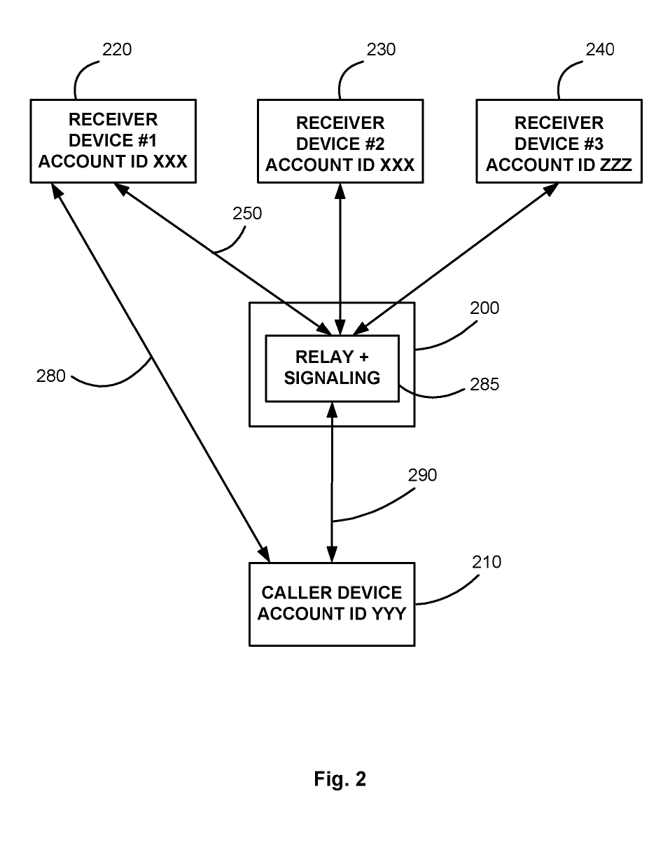

FIG. 2 is a schematic drawing showing the data transmission routes according to the present invention.

A caller 210, using the VVoIP client application on her communication device having account ID YYY, communicates 290 to the service 200 an account ID XXX (e.g. user ID, e-mail address, phone number) to be called. The service 200 may communicate the request to the client applications on all the devices (220, 230) having the same account ID YYY (optionally with an active/inactive flag), via a software relay mechanism 285, which may be implemented, for example, as a table mapping account-IDs to DIDs.

One of the multiple devices (e.g. 220) may pick up the call, whereby a communication session is established between device 220 and the caller 210, either directly, in a peer-to-peer (P2P) model via a media channel 280, or via the software relay 285 of the service (250, 290).

According to embodiments of the invention, during a VVoIP call, the active device being one of a plurality of devices sharing the same account ID XXX may wish to transfer the call to one of the other devices sharing account ID XXX or to a device (e.g. 240) having a different account ID ZZZ or to a specific “paired” device or list of devices.

For example, a call started on a user's computer may be continued on the user's smartphone if the user wishes to leave her home/office, or the call may be transferred to some other account ID (call forwarding).

According to embodiments of the present invention, the call may be transferred to a device in NFC communication with the active device. If a device active in a call is brought close to another device, the proximity may be a signal that a transfer is requested. The devices may exchange information via NFC whereby the call transfer may be done directly between the two devices.

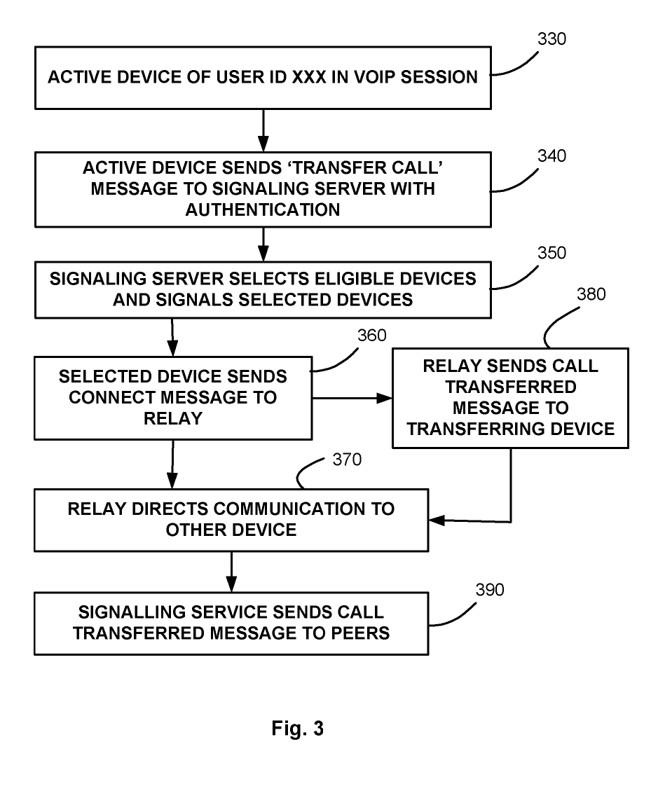

FIG. 3 is a flowchart showing the call transfer mechanism according to this embodiment.

In step 330, a VVoIP call has been established between the initiator (account ID YYY) and one of the multiple devices sharing account ID XXX, i.e. the active device (e.g. 220). The session may be carried out via the relay service or as a P2P session via a direct channel.

In step 340 the user (account ID XXX) wishes to transfer the call from the currently active device (e.g. 220) to one or more of the other devices sharing her account ID (e.g. 230), or to another device having a different account ID (e.g. 240).

The transferring device (e.g. 220) sends a “transfer” message to a signaling server/service, optionally integrated within the relay 285.

The service then finds what other devices are eligible to accept the call, e.g. all other devices sharing the same account ID, or in the case of the call being forward to another account—all devices belonging to that other account, and signals (step 350) the selected device(s) by sending a “transfer call” message via signaling to each of these devices.

Two items of information are required before a call can be transferred:
1. The new device must know where the call is being relayed.

Usually, this would mean IP/port of the relay. In some instances this may not be necessary: a fixed IP/port may be used (especially in small configurations).

If multiple calls share the same IP/port (for example, in the fixed IP/port option above), some other identifier for the call is required—e.g. the call token.

In principle, neither of these must be sent to the new device: the relay information may be decided in advance, for example for each account ID (e.g. if account ID is 666, the port used would be 666). However, in practical situations with multiple calls, either or both of the IP/port or call token would be required.
2. Authentication information—the new device should authenticate itself as being “eligible” to receive the call.

For authentication, no data need to be sent either—assuming the transfer is to another device in the same account ID, the new device needs to authenticate itself as belonging to the account. This could be done for example, by a challenge/response mechanism using a shared secret (e.g. a password).

Alternatively, we could use an implicit authentication—if the new device connects to the right port and/or has the right call token, we can implicitly accept it, or if it knows the ID of the transferring device.

In addition to the above, a “transfer call” message may contain metadata about the call—e.g. the account ID of the peer; the ID of the transferring device, etc.

According to some embodiments, the client application may display to the user a list of devices in close proximity, from which he may select a specific device to which the call is to be transferred, using for example technologies such as Apple Bonjour, Qualcomm's AllJoyn and others.

In this case, the peer-to-peer protocol (e.g. Bonjour) allows the devices to “discuss” the transfer without the need of signaling; once the user picks a device to transfer to, the transferring device notifies that device and the relay of the transfer, following which the process proceed as described below.

A device receiving the transfer message from the signaling service may “pick up” the call by sending a “connect” message (step 360) to the relay, including its own authentication information as described above.

The relay then updates its tables and directs (step 370) all traffic pertaining to the VVoIP call from the transferring device ID to the new Device ID.

In addition, the relay sends a “call transferred” message to the transferring device (step 380), either directly on the voice channel—or via the signaling service.

The signaling service may send a similar “call transferred” message (step 390) to all peers (i.e. all the devices sharing account ID YYY and all the devices sharing account ID XXX or ZZZ).

In case the call was a P2P call (i.e. did not pass through the relay), the “call transferred” message sent by the signaling service to the peers may notify the peers that the direct channel is no longer usable and traffic should pass via the relay. A peer-to-peer negotiation may then start again.

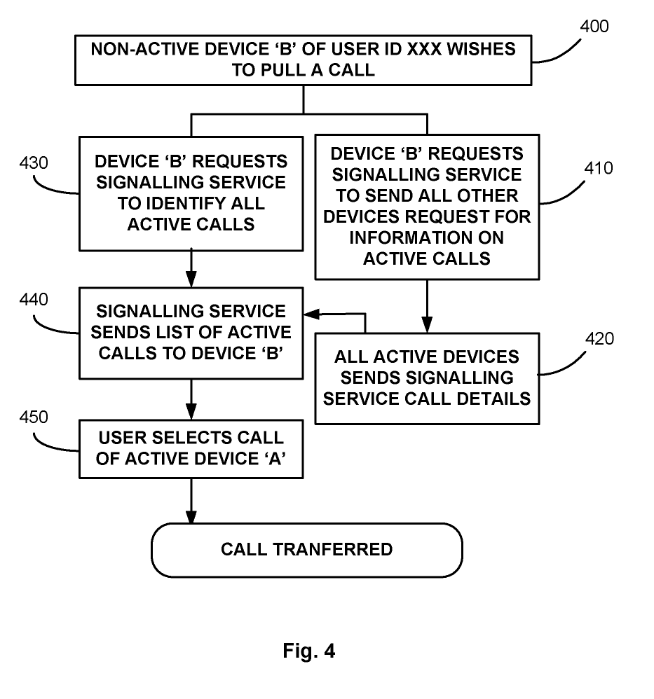

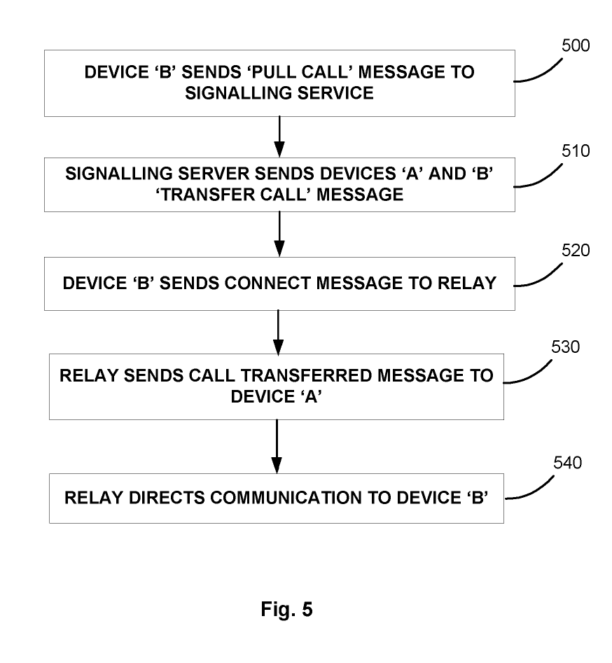

According to another embodiment of the present invention, as depicted in FIGS. 4 and 5, during a VVoIP call, a non-active device sharing the same account ID XXX as the active device may wish to “pull” the conversation (step 400).

The non-active device may “discover” active calls by one of the following methods:

1. Sending a message through the service—either asking the signaling service of any active calls for the current account ID (step 430), whereby the signaling service will respond with a list of all active calls (step 440) or requesting the signaling service to forward a request to provide information regarding active calls to all other devices (step 410), whereby a device with an active call will reply with details of the call (step 420). In both these implementations the pulling device must request information regarding which calls are currently active. This request would most likely be triggered by a user operation. For example, the user clicks “pull call”—a pull request is sent, and the user can then choose (step 450) which call to pull if there is more than one; if there's only one call in progress in the account, the device can either pull it automatically or notify the user as before. Alternatively, the pulling device can forgo discovery and just request to pull any call currently in progress. If there is more than a single call—the pulling device can pull either call.

2. Discovering proximate devices via P2P network—e.g. using services such as AllJoyn, Apple's Bonjour etc. In this case, upon discovery of another device, the inactive device will check if the discovered device belongs to the same account, For example by broadcasting a request to report account-ID by all devices and then performing an authentication using e.g. the user's password and established security protocols e.g. challenge/response.

If the discovered device is determined to belong to the same account, the discovering device may directly request for details of any active call, e.g. call token and peer's phone number).

3. Active device (or service) may constantly report call-state changes to all other devices sharing the same account ID. This way, all the devices “know” what calls are currently in progress and what device those calls are running on.

In all cases requiring selection of a call, the pulling device has a list of active calls—with at least the ID of the active device (the call-token may also suffice, assuming the service knows what calls are currently active).

To perform the pull, as depicted in FIG. 5, the pulling device can:
1. Send a request to the active device (through P2P means—e.g. Bonjour—or via the service) or to the signaling service (step 500) to pull the call. The active device will then start a “push” transfer call, but with only a single device as the potential target (i.e. the pulling device). In step 510 the signaling service sends both devices a “transfer call” message. In step 520 pulling device ‘B’ sends a “connect” message to the relay and in step 530 the relay sends a “call transferred” message to device ‘A’ and directs all communication pertaining to the selected call to device ‘B’ (step 540).
2. Alternatively, assuming the pulling device has received all the relevant details in the discovery stage (i.e. the call token and the active device ID), the pulling device can just start the call-transfer procedure as if it received the call-transfer message. In addition, it can (but doesn't have to) notify the active device that a transfer is in progress

In the case where the pulling device forgoes discovery, option (1) will cause the call to be transferred.

In all the embodiments described above, when a new device replaces a previously active device in a call, it performs handshaking with the other peer to checks capabilities, e.g. voice CODEC supported, video capabilities, etc.

1. A method of pushing an ongoing VVoIP call from a first currently participating communication device belonging to an account having an account ID to a second communication device, comprising:
sending by the first communication device a ‘transfer call’ message to a signaling service;
sending by the signaling service the ‘transfer call’ message to at least one selected second communication device;
if the call is not a P2P call, sending by one of the at least one selected second communication devices a ‘connect’ message to a relay server, said message comprising authentication information;
sending by the signaling service a “call transferred” message to the first communication device; and
continuing said ongoing call with said selected second communication device replacing said first communication device.

2. The method of claim 1, wherein said ‘transfer call’ message comprises the relay server's IP port.

3. The method of claim 1, wherein said first and second communication devices share the same account ID.

4. The method of claim 3, wherein said authentication information comprises authenticating belonging to the same account ID.

5. The method of claim 1, wherein said authentication information comprises at least one of a device ID and a call token.

6. The method of claim 1, wherein said account ID comprises one of: user ID, e-mail address and phone number.

7. The method of claim 1, wherein said second communication device is selected by said first communication device.

8. The method of claim 6, wherein said second communication device is selected from communication devices being in near proximity to said first communication device.

9. The method of claim 1, wherein said call is a P2P call and wherein said sending by the signaling service the ‘transfer call’ message to at least one selected second communication device comprises notifying said second communication device that traffic should pass via the relay server.

10. A method of pulling an ongoing VVoIP call from a first currently participating communication device to a second non-active communication device sharing the same account ID, comprising:
discovering by said second device current active calls in said account ID;
sending a request to a signaling service to pull a call from a first active device in one of said active calls;
sending by a signaling service a ‘transfer call’ message to said first device and to said second device;
if the call is not a P2P call, sending by said second device a ‘connect’ message to a relay server, said message comprising authentication information;
sending by the signaling service a “call transferred” message to the first communication device; and
continuing said ongoing call with said second communication device replacing said first communication device.

11. The method of claim 10, wherein said ‘transfer call’ message comprises the relay server's IP port.

12. The method of claim 10, wherein said authentication information comprises authenticating belonging to the same account ID.

13. The method of claim 10, wherein said authentication information comprises at least one of a device ID and a call token.

14. The method of claim 10, wherein said account ID comprises one of: user ID, e-mail address and phone number.

15. The method of claim 10, wherein said first communication device is selected from communication devices being in near proximity to said second communication device.

16. The method of claim 10, wherein said call is a P2P call and wherein said sending by the signaling service the ‘transfer call’ message to said second communication device comprises notifying said second communication device that traffic should pass via the relay server.

17. The method of claim 7, wherein said authentication data comprises at least one of a device ID and a call token.

18. The method of claim 7, wherein said first and second communication devices share the same account ID.

19. The method of claim 9, wherein said account ID comprises one of: user ID, e-mail address and phone number.

20. A method of pulling an ongoing VVoIP call from a first currently participating communication device to a second proximate non-active communication device, comprising:
receiving by said second communication device the call data from said first communication device;
sending by said second communication device a ‘connect’ message to a relay server, said message comprising authentication data of said second communication device;
sending by the relay server a ‘call transferred’ message to the first communication device; and
continuing said ongoing call with said second communication device replacing said first communication device.

21. The method of claim 20, wherein said authentication data comprises at least one of a device ID and a call token.
